(19) United States
(12) Patent Application Publication
(10) Pub. No.: US 2023/0396371 A1
(43) Pub. Date: Dec. 7, 2023

(54) TYPE-1 HARQ-ACK CODEBOOK WITH RELATIVE SLIV

(71) Applicant: Telefonaktiebolaget LM Ericsson (PUBL), Stockholm (SE)

(72) Inventors: Yufei Blankenship, KILDEER, IL (US); Kittipong Kittichokechai, JÄRFÄLLA (SE)

(21) Appl. No.: 18/033,024

(22) PCT Filed: Oct. 25, 2021
(86) PCT No.: PCT/IB2021/059834

§ 371 Date: Apr. 20, 2023

Related U.S. Application Data
(60) Provisional application No. 63/104,802, filed on Oct. 23, 2020.

(51) Int. Cl. H04L 1/1829; H04L 5/00

(52) U.S. Cl. CPC H04L 1/1854; H04L 5/0055

(57) ABSTRACT

According to some embodiments, a method is performed by a wireless device capable of operating in a wireless network where physical downlink control channel (PDCCH) monitoring occasions vary by slot. The method comprises: obtaining a starting symbol S of a physical downlink shared channel (PDSCH), wherein S is relative to a reference symbol related to a PDCCH monitoring occasion where the PDSCH is scheduled; deriving a Type-1 hybrid automatic repeat request (HARQ) acknowledgement (ACK) codebook based on the starting symbol S; and transmitting to a network node one or more HARQ-ACKs based on the HARQ-ACK codebook.

### TECHNICAL FIELD

Embodiments of the present disclosure are directed to wireless communications and, more particularly, to Type-1 hybrid automatic repeat request (HARD) acknowledgment codebook with relative start and length indicator (SLIV).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) new radio (NR) provides service for multiple use cases such as enhanced mobile broadband (eMBB), ultra-reliable and low latency communication (URLLC), and machine type communication (MTC). Each of the services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot is a concept that is used in scheduling and in downlink a mini-slot can consist of 2, 4 or 7 orthogonal frequency division multiplexing (OFDM) symbols, while in uplink a mini-slot can be any number of 1 to 14 OFDM symbols. The concepts of slot and mini-slot are not specific to a specific service meaning that a mini-slot may be used for either eMBB, URLLC, or other services.

FIG. 1 is a time frequency diagram illustrating an example radio resource in NR. The horizontal axis represents time and the other axis represents frequency with 15 kHz subcarrier spacing.

In 3GPP NR standards, downlink control information (DCI), which is transmitted in physical downlink control channel (PDCCH), indicates the downlink data related information, uplink related information, power control information, slot format indication, etc. There are different formats of DCI associated with each of these control signals and the UE identifies them based on different radio network temporary identifiers (RNTIs).

A UE is configured by higher layer signaling to monitor for DCIs in different resources with different periodicities, etc. DCI formats 1_0, 1_1, and 1_2 are used for scheduling downlink data, which is sent in physical downlink shard channel (PDSCH), and includes time and frequency resources for downlink transmission, as well as modulation and coding information, HARQ (hybrid automatic repeat request) information, etc.

For downlink semi-persistent scheduling (SPS) and uplink configured grant type 2, part of the scheduling, including the periodicity, is provided by the higher layer configurations, while the rest of scheduling information, such as time domain and frequency domain resource allocation, modulation and coding, etc., are provided by the DCI in PDCCH.

A UE can indicate a capability to monitor PDCCH according to one or more of the combinations (X, Y)=(2, 2), (4, 3), and (7, 3) per subcarrier spacing (SCS) configuration of μ=0 and μ=1. A span is a number of consecutive symbols in a slot where the UE is configured to monitor PDCCH. Each PDCCH monitoring occasion is within one span. If a UE monitors PDCCH on a cell according to combination (X, Y), the UE supports PDCCH monitoring occasions in any symbol of a slot with minimum time separation of X symbols between the first symbol of two consecutive spans, including across slots. A span starts at a first symbol where a PDCCH monitoring occasion starts and ends at a last symbol where a PDCCH monitoring occasion ends, where the number of symbols of the span is up to Y.

If a UE indicates a capability to monitor PDCCH according to multiple (X, Y) combinations and a configuration of search space sets to the UE for PDCCH monitoring on a cell results to a separation of every two consecutive PDCCH monitoring spans that is equal to or larger than the value of X for one or more of the multiple combinations (X, Y), the UE monitors PDCCH on the cell according to the combination (X, Y), from the one or more combinations (X, Y), that is associated with the largest maximum number of M_{PDCCH}^{max,(X,Y),μ} and C_{PDCCH}^{max,(X,Y),μ} defined in Table 10.1-2A and Table 10.1-3A. The UE expects to monitor PDCCH according to the same combination (X, Y) in every slot on the active downlink bandwidth part (BWP) of a cell.

Uplink control information (UCI) is a control information sent by a UE to a gNB. It consists of: Hybrid-ARQ acknowledgement (HARQ-ACK), which is a feedback information corresponding to the received downlink transport block whether the transport block reception is successful or not; channel state information (CSI) related to downlink channel conditions which provides the gNB with channel-related information useful for downlink scheduling, including information for multi-antenna and beamforming schemes; and scheduling request (SR), which indicates a need of uplink resources for uplink data transmission.

UCI is typically transmitted on physical uplink control channel (PUCCH). However, if a UE is transmitting data on the PUSCH with a valid PUSCH resource overlapping with PUCCH, UCI can be multiplexed with uplink data and transmitted on PUSCH instead, if the timeline requirements for UCI multiplexing is met.

Physical uplink control channel (PUCCH) is used by a UE to transmit HARQ-ACK feedback message corresponding to the reception of downlink data transmission. It is also used by the UE to send channel state information (CSI) or to request for an uplink grant for transmitting uplink data.

NR includes multiple PUCCH formats supporting different UCI payload sizes. PUCCH formats 0 and 1 support UCI up to 2 bits, while PUCCH formats 2, 3, and 4 can support UCI of more than 2 bits. In terms of PUCCH transmission duration, PUCCH formats 0 and 2 are considered short PUCCH formats supporting PUCCH duration of 1 or 2 OFDM symbols, while PUCCH formats 1, 3, and 4 are considered as long formats and can support PUCCH duration from 4 to 14 symbols.

HARQ feedback is used for error correction and control. The procedure for receiving downlink transmission is that a UE first monitors and decodes a PDDCH in slot n which points to downlink data scheduled in slot n+K₀ slots (K₀ is larger than or equal to 0). The UE then decodes the data in the corresponding PDSCH.

Based on the outcome of the decoding, the UE sends an acknowledgement of the correct decoding (ACK) or a negative acknowledgement (NACK) to the gNB at time slot n+K₀+K₁ (in case of slot aggregation n+K₀ would be replaced by the slot where the PDSCH ends). Both of K₀ and K₁ are indicated in the DCI.

The resources for sending the acknowledgement are indicated by PUCCH resource indicator (PRI) field in the DCI which points to one of the PUCCH resources that are configured by higher layers.

Depending on downlink/uplink slot configurations, or whether carrier aggregation, or per code-block group (CBG) transmission is used in the downlink, the feedback for several PDSCHs may need to be multiplexed in one feedback. This is done by constructing HARQ-ACK codebooks. In NR, the UE can be configured to multiplex the A/N bits using a semi-static codebook or a dynamic codebook.

Type 1 or semi-static codebook consists of a bit sequence where each element contains the A/N bit from a possible allocation in a certain slot, carrier, or transport block (TB). When the UE is configured with CBG and/or time-domain resource allocation (TDRA) table with multiple entries, multiple bits are generated per slot and TB. It is important to note that the codebook is derived regardless of the actual PDSCH scheduling. The size and format of the semi-static codebook is preconfigured based on the parameters above. A drawback of a semi-static HARQ ACK codebook is that the size is fixed, and regardless of whether there is a transmission or not a bit is reserved in the feedback matrix.

When a UE has a TDRA table with multiple time-domain resource allocation entries configured, the table is pruned (i.e., entries are removed based on a specified algorithm) to derive a TDRA table that only contains non-overlapping time-domain allocations. One bit is then reserved in the HARQ codebook for each non-overlapping entry (assuming a UE is capable of supporting reception of multiple PDSCH in a slot).

To avoid reserving unnecessary bits in a semi-static HARQ codebook, in NR a UE can be configured to use a type 2 or dynamic HARQ codebook, where an A/N bit is present only if there is a corresponding transmission scheduled. To avoid any confusion between the gNB and the UE, on the number of PDSCHs that the UE has to send a feedback for, a counter downlink assignment indicator (DAI) field exists in the downlink assignment, which denotes accumulative number of {serving cell, PDCCH occasion} pairs in which a PDSCH is scheduled to a UE up to the current PDCCH. In addition, the total DAI field, when present, shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K₀) and the PUCCH slot that contains HARQ feedback (K₁).

FIG. 2 illustrates a transmission timeline in a simple scenario with two PDSCHs and one HARQ feedback. In the illustrated example there is in total 4 PUCCH resources configured, and the PRI indicates PUCCH 2 to be used for HARQ feedback. The following explains how PUCCH 2 is selected from 4 PUCCH resources based on the procedure in Rel-15.

Typically, a UE is scheduled to receive PDSCH by a DCI where the time domain resource allocation of the PDSCH is indicated by the start and length indicator (SLIV) in the DCI. The SLIV indicates the starting symbol (S) and length (L) of the PDSCH where S is with respect to the slot boundary.

In Rel-16, a UE can be configured with an RRC parameter referenceOfSLIVForDCI-Format1-2-r16 indicating a possible new reference for S in the indicated SLIV.

When a UE is configured with referenceOfSLIVForDCI-Format1-2-r16 and is scheduled to receive PDSCH by a DCI format 1_2 with CRC scrambled by C-RNTI, MCS-C-RNTI, CS-RNTI and with the slot offset K0=0, and PDSCH mapping Type B, the starting symbol S of the indicated SLIV is relative to the starting symbol S0 of the PDCCH monitoring occasion where the DCI format 1_2 is detected. Otherwise, the starting symbol S is relative to the start of the slot, i.e., using S0=0.

The UE shall consider the S and L combinations defined in table 5.1.2.1-1 of TS 38.214 satisfying S₀+S+L≤14 for normal cyclic prefix and S₀+S+L≤12 for extended cyclic prefix as valid PDSCH allocations.

There currently exist certain challenges. For example, for Type-1 HARQ-ACK codebook construction, the current NR specification does not take into account that the set of possible PDCCH monitoring occasions may vary from slot to slot, when reference for SLIV is applied to PDSCH time domain resource allocation (TDRA). When reference for SLIV is applied with the slot offset K₀=0 and PDSCH mapping Type B, the starting symbol S of a scheduled PDSCH is relative to the starting symbol S₀ of the PDCCH monitoring occasion where DCI format 1_2 is detected.

### SUMMARY

Based on the description above, certain challenges currently exist with Type-1 hybrid automatic repeat request (HARD) acknowledgement (ACK) codebook construction. Certain aspects of the present disclosure and their embodiments may provide solutions to these or other challenges. For example, particular embodiments include methods to enable the use of Type-1 HARQ-ACK codebook in general when a UE can be configured with a new reference for start and length indicator (SLIV).

In some embodiments, when the UE is configured with a new reference for SLIV, a common set R containing relevant time-domain resource allocation (TDRA) entries with possible starting symbol of physical downlink control channel (PDCCH) monitoring occasions is derived and used in the Type-1 HARQ-ACK codebook determination for all slots. Alternatively, the application of Type-1 HARQ-ACK codebook is restricted to certain cases depending on the configurations of the new reference for SLIV and/or PDCCH monitoring occasions.

In some embodiments, a set R containing relevant TDRA entries with a possible different starting symbol of PDCCH monitoring occasions is allowed to vary across slots depending on the configuration of PDCCH monitoring occasions.

According to some embodiments, a method is performed by a wireless device capable of operating in a wireless network where physical PDCCH monitoring occasions vary by slot. The method comprises: obtaining a starting symbol S of a physical downlink shared channel (PDSCH), wherein S is relative to a reference symbol related to a PDCCH monitoring occasion where the PDSCH is scheduled; deriving a Type-1 HARQ-ACK codebook based on the starting symbol S; and transmitting to a network node one or more HARQ-ACKs based on the HARQ-ACK codebook.

In particular embodiments, deriving the Type-1 HARQ-ACK codebook comprises deriving a set R containing TDRA entries for PDSCH reception with possible starting symbol of PDCCH monitoring occasions.

In particular embodiments, the set R is common for all slots. In some embodiments, all PDCCH monitoring occasion of a span start at the same symbol, a same span pattern repeats in all slots, and starting symbol S is relative to a starting symbol of a monitoring span that contains the PDCCH monitoring occasion where the PDSCH is scheduled. In some embodiments, the Type-1 HARQ-ACK codebook is only derived if starting symbols of PDCCH monitoring occasions are configured the same in all slots. Where PDCCH monitoring occasions are absent in some slots, the Type-1 HARQ-ACK codebook may only be derived if starting symbols of PDCCH monitoring occasions, if not absent, are configured the same in all slots. In some embodiments, the set R includes entries derived from all starting symbols of PDCCH monitoring occasions across all slots.

In particular embodiments, the set R varies across slots.

In particular embodiments, deriving the set R is based on monitoring limits of the wireless device and/or avoiding entries that result in overlapping PDSCH reception candidates.

According to some embodiments, a wireless device comprises processing circuitry operable to perform any of the methods of the wireless device described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a network node capable of operating in a wireless network where PDCCH monitoring occasions vary by slot. The method comprises: transmitting to a wireless device a starting symbol S of a PDSCH, wherein S is relative to a reference symbol related to a PDCCH monitoring occasion where the PDSCH is scheduled; and receiving from the wireless device HARQ-ACK based on a HARQ-ACK codebook and the starting symbol S.

According to some embodiments, a network node network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments enable the use of Type-1 HARQ-ACK codebook when a UE is configured with a new reference for SLIV and is scheduled with DCI format 1_2.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a time frequency diagram illustrating an example radio resource in new radio (NR);

FIG. 2 illustrates a transmission timeline in a simple scenario with two physical downlink shared channels (PDSCHs) and one hybrid automatic repeat request (HARQ) feedback;

FIG. 3 is a timing diagram illustrating an example of configured monitoring occasions, where each slot has monitoring occasions with different starting symbol;

FIG. 4 is a timing diagram illustrating an example of configured monitoring occasions, where each slot has monitoring occasions with the same starting symbols;

FIG. 5 is a timing diagram illustrating an example of configured monitoring occasions, where each slot has monitoring occasions with the same starting symbols if the monitoring occasions exist in a slot;

FIG. 6 is a block diagram illustrating an example wireless network;

FIG. 7 illustrates an example user equipment, according to certain embodiments;

FIG. 8 is flowchart illustrating an example method in a wireless device, according to certain embodiments;

FIG. 9 is a flowchart illustrating an example method in a network node, according to certain embodiments;

FIG. 10 illustrates a schematic block diagram of a wireless device and network node in a wireless network, according to certain embodiments;

FIG. 11 illustrates an example virtualization environment, according to certain embodiments;

FIG. 12 illustrates an example telecommunication network connected via an intermediate network to a host computer, according to certain embodiments;

FIG. 13 illustrates an example host computer communicating via a base station with a user equipment over a partially wireless connection, according to certain embodiments;

FIG. 14 is a flowchart illustrating a method implemented, according to certain embodiments;

FIG. 15 is a flowchart illustrating a method implemented in a communication system, according to certain embodiments;

FIG. 16 is a flowchart illustrating a method implemented in a communication system, according to certain embodiments; and

FIG. 17 is a flowchart illustrating a method implemented in a communication system, according to certain embodiments.

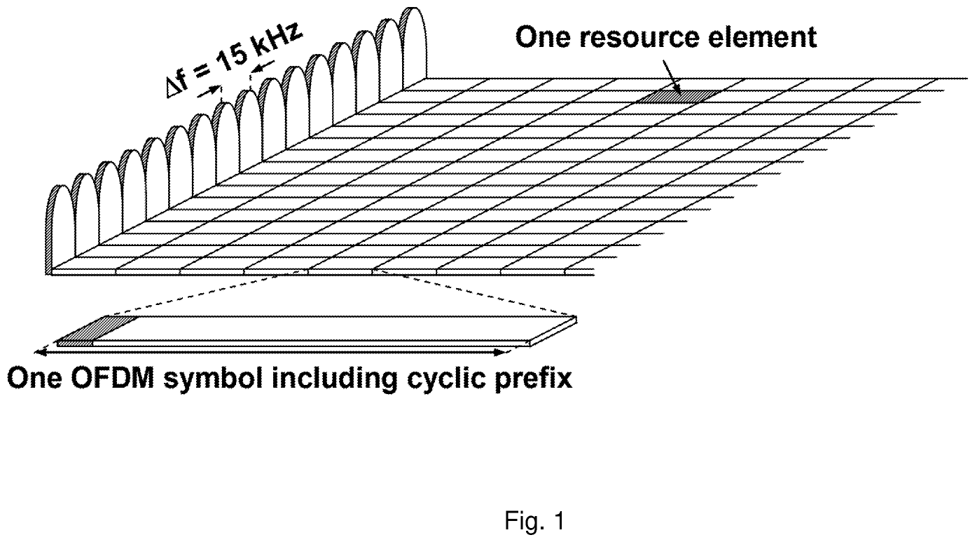

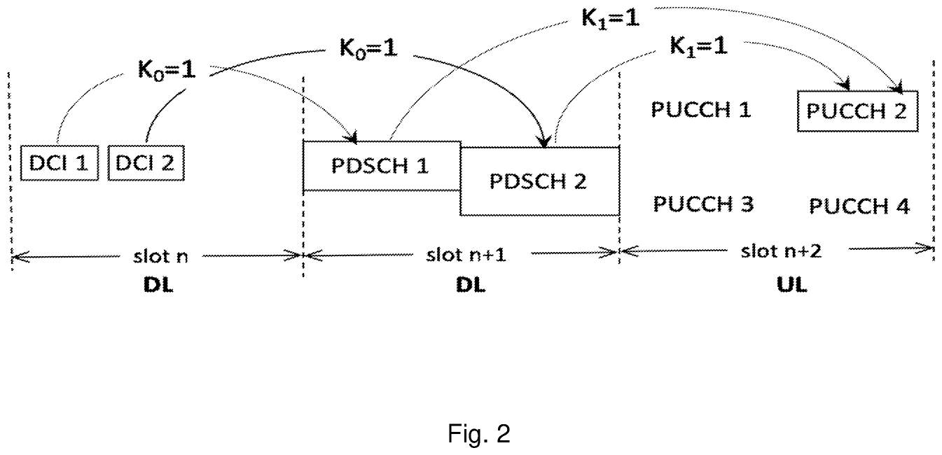

### DETAILED DESCRIPTION

As described above, certain challenges currently exist with Type-1 hybrid automatic repeat request (HARQ) acknowledgement (ACK) codebook construction. Certain aspects of the present disclosure and their embodiments may provide solutions to these or other challenges. For example, particular embodiments include methods to enable the use of Type-1 HARQ-ACK codebook in general when a UE can be configured with a new reference for start and length indicator (SLIV).

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

The embodiments described herein can be applied to both HARQ-ACK feedback of dynamically scheduled physical downlink shard channel (PDSCH) and that of downlink semi-persistent scheduling (SPS). They are also applicable to HARQ-ACK with slot-based and subslot-based HARQ-ACK codebooks.

A “PDCCH monitoring occasion” in existing specifications is interpreted as the monitoring occasions in each slot. The span pattern does not have to be the same across slots. But the same (X,Y) is satisfied across slots.

There are restrictions to configuration to define a common set R for all slots. Currently, when relative SLIV is used, the reference point S₀ for starting symbol S is defined based on physical downlink control channel (PDCCH) monitoring occasion is determined as follows. if configured with referenceOfSLIVForDCI-Format1-2-r16, and when receiving PDSCH scheduled by DCI format 1_2 with CRC scrambled by C-RNTI, MCS-C-RNTI, CS-RNTI with K₀=0, and PDSCH mapping Type B, the starting symbol S is relative to the starting symbol S₀ of the PDCCH monitoring occasion where DCI format 1_2 is detected.

However, the monitoring occasion is RRC configured according to search space set configurations for PDCCH monitoring, and one monitoring span may contain multiple different starting symbols of monitoring occasions.

To have a common set R for all slots, enhancements are needed. When a common set R is built for all slots, then the set R can be built, stored, and applied for Type-1 HARQ-ACK codebook construction for any slot. That is, the set R does not need to be built in real-time when Type-1 HARQ-ACK codebook is needed for a slot.

A first group of embodiments change the definition of starting symbol S₀. In some embodiments, for Type-1 HARQ-ACK codebook, the number of rows in set R is reduced if the starting symbol S0 is defined as the starting symbol S₀ of the monitoring span which contains the PDCCH monitoring occasion where DCI format 1_2 is detected. This effectively requires that the gNB configures all monitoring occasions of a span to start at the same symbol, and the same span pattern repeats in all slots.

For example, on a set of row indexes R of a table that is associated with the active downlink bandwidth part (BWP) and defining respective sets of slot offsets K₀, start and length indicators SLIV, and PDSCH mapping types for PDSCH reception as described in TS 38.214, where the row indexes R of the table are provided by the union of row indexes of time domain resource allocation tables for DCI formats the UE is configured to monitor PDCCH for serving cell c, if the UE is provided ReferenceofSLIV-ForDCIFormat1_2, for each row index with slot offset K₀=0 and PDSCH mapping Type B in a set of row indexes of a table for DCI format 1_2 [TS 38.214], for each PDCCH monitoring occasion in a set of PDCCH monitoring occasions with different starting symbols within a slot where the UE monitors PDCCH for DCI format 1_2 and with starting symbol S₀>0, if S+S₀+L≤14 for normal cyclic prefix and S+S₀+L≤12 for extended cyclic prefix, add a new row index in the set of row indexes of the table by replacing the starting symbol S of the row index by S+S₀. Here S₀ is the starting symbol S₀ the monitoring span which contains the PDCCH monitoring occasion where DCI format 1_2 is detected.

A second group of embodiments limit the applicable scenarios of Type-1 HARQ-ACK codebook. In some embodiments, the applicable scenarios of Type-1 HARQ-ACK codebook is limited to certain cases, depending on the configurations of the new reference for SLIV and/or PDCCH monitoring occasions.

In some embodiments, the gNB configures Type-1 HARQ-ACK codebook only if relative SLIV is not applied. That is, the UE is not provided with ReferenceofSLIV-ForDCIFormat1_2.

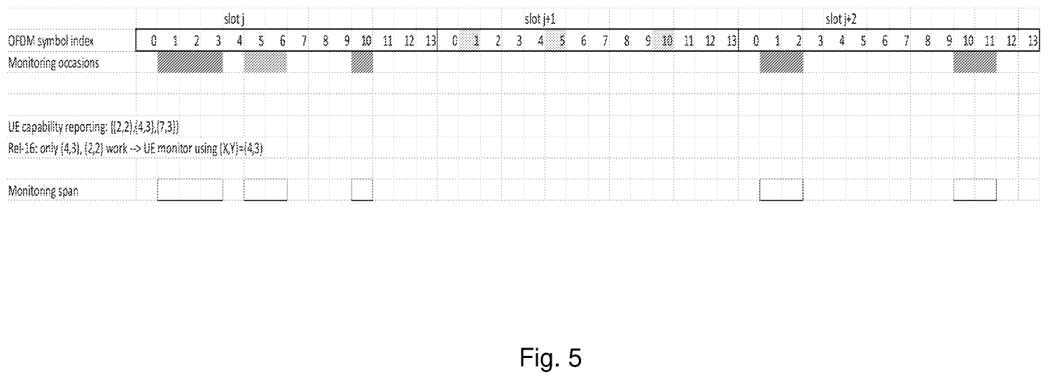

In some embodiments, the gNB configures Type-1 HARQ-ACK codebook with relative SLIV, only if the starting symbols of PDCCH monitoring occasions are configured the same in all slots. In particular embodiments, the monitoring occasions are allowed to be absent in a given slot, and the starting symbols of PDCCH monitoring occasions, if not absent, are configured the same in all slots. This variation is illustrated in FIG. 5 described in more detail below.

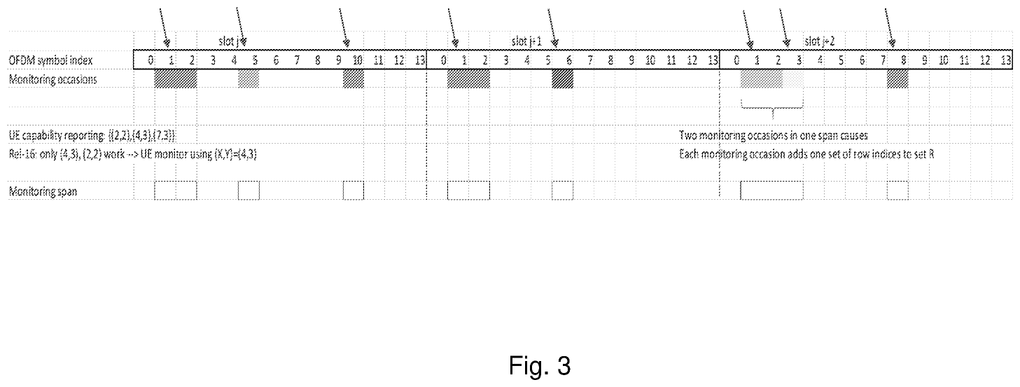

FIG. 3 is a timing diagram illustrating an example of configured monitoring occasions, where each slot has monitoring occasions with different starting symbol (arrows) and may cause the set R to be very large if using relative SLIV. FIG. 3 illustrates monitoring occasions in 3 slots (slot j, (j+1), (j+2)). The number of monitoring occasions in each slot, as well as starting symbols of the monitoring occasions in each slot, are all different. This may cause the set R to be very large if using relative SLIV.

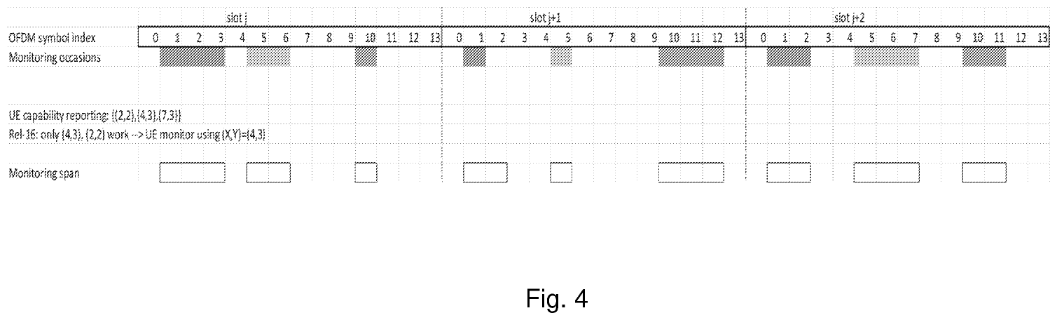

FIG. 4 is a timing diagram illustrating an example of configured monitoring occasions, where each slot has monitoring occasions with the same starting symbols (e.g., symbols 1, 5, 10) and does not unnecessarily cause R to be large. As illustrated, constraints are applied to the CORESET and/or search space configurations, so that the starting symbols of monitoring occasions in each slot are the same. Note that the end symbols of the monitoring occasions in each slot do not need to be the same. For example, the monitoring occasions with starting symbol=1 in the three slots end in symbol #3, #1, and #2, respectively.

A third group of embodiments considers all possible starting symbols S₀ of PDCCH monitoring occasions in all slots when forming the set R. In some embodiments, for Type-1 HARQ-ACK codebook, the set R includes row indices derived from all possible starting symbols S₀ of PDCCH monitoring occasions according to all the search space set configurations across slots. That is, for each row index in the TDRA table for DCI format 1_2 with slot offset K₀=0 and PDSCH mapping Type B, add new row indices by replacing the starting symbol S of the row index by S+S₀ for all starting symbols S₀ of PDCCH monitoring occasions of the search space set of DCI format 1_2.

Note here that a difference from the existing specification is that all starting symbols S₀ of PDCCH monitoring occasions according to all the search space set configurations across slots are considered instead of just from those within a slot.

For example, on a set of row indexes R of a table that is associated with the active downlink BWP and defining respective sets of slot offsets K₀, start and length indicators SLIV, and PDSCH mapping types for PDSCH reception as described in [TS 38.214], where the row indexes R of the table are provided by the union of row indexes of time domain resource allocation tables for DCI formats the UE is configured to monitor PDCCH for serving cell c, if the UE is provided ReferenceofSLIV-ForDCIFormat1_2, for each row index with slot offset K₀=0 and PDSCH mapping Type B in a set of row indexes of a table for DCI format 1_2 [TS 38.214], for each PDCCH monitoring occasion in a set of PDCCH monitoring occasions across slots with different starting symbols where the UE monitors PDCCH for DCI format 1_2 and with starting symbol S₀>0, if S+S₀+L≤14 for normal cyclic prefix and S+S₀+L≤12 for extended cyclic prefix, add a new row index in the set of row indexes of the table by replacing the starting symbol S of the row index by S+S₀.

Some embodiments support a set R that varies from slot to slot. For example, the set R is not required to be the same across slots. Instead, the set R can vary from slot to slot, based on the monitoring occasion configuration in each slot. This is versatile, but a consequence is the number of HARQ-ACK bits in each slot varies for a given component carrier.

In this method, when constructing HARQ-ACK codebook for a given slot, the set R is custom built based on the monitoring occasion configuration of the related downlink slot, where the downlink slot contains the potential PDSCH that the HARQ-ACK responds to. Thus, the UE cannot prepare and store a set R beforehand and use it for any slot. That is, the set R needs to be built in real-time when Type-1 HARQ-ACK codebook is needed for a particular slot.

For example, on a set of row indexes R′ of a table that is associated with the active downlink BWP and defining respective sets of slot offsets K₀, start and length indicators SLIV, and PDSCH mapping types for PDSCH reception as described in [TS 38.214], where the row indexes R′ of the table are provided by the union of row indexes of time domain resource allocation tables for DCI formats the UE is configured to monitor PDCCH for serving cell c
Set j=0—index of occasion for candidate PDSCH reception or SPS PDSCH release
Set B=Ø
Set M_{A,c}=Ø
Set [symbol] (K₁) to the cardinality of set K₁
Set k=0—index of slot timing values K_{1,k}, in descending order of the slot timing values, in set K₁ for serving cell C
   If a UE is not provided ca-SlotOffset for any serving cell of PDSCH receptions and for the serving cell of corresponding PUCCH transmission with HARQ-ACK information

```
while ^{k <} [symbol] ^{(K}₁⁾
  if ^{mod (n}_{U} ^{-K}_{1,k}^{+ 1, max(2μ}_{UL} ^{- μ}_{DL}^{,1)) = 0}
    Set ^{nD = 0} − index of a DL slot within an UL slot
    while ⁿ_{D} ^{<} max(2 ^{μ}_{DL} ⁻ ^{μ}_{UL} ,1)
      Set ^{R} to the set of rows.
```

If ReferenceofSLIV-ForDCIFormat1_2 is not provided, set R is equal to set R′. Otherwise, set R is obtained from R′ by adding new rows due to ReferenceofSLIV-ForDCIFormat1_2. Initialize set R to R′. If the UE is provided ReferenceofSLIV-ForDCIFormat1_2, for each row index with slot offset K₀=0 and PDSCH mapping Type B in a set of row indexes of a table for DCI format 1_2 [TS 38.214], for each PDCCH monitoring occasion in a set of PDCCH monitoring occasions with different starting symbols within DL slot n_{D} where the UE monitors PDCCH for DCI format 1_2 and with starting symbol S₀>0, if S+S₀+L≤14 for normal cyclic prefix and S+S₀+L≤12 for extended cyclic prefix, add a new row index to the set R′ of row indexes of the table by replacing the starting symbol S of the row index by S+S₀. When receiving PDSCH scheduled by DCI format 1_2 with CRC scrambled by C-RNTI, MCS-C-RNTI, CS-RNTI with K₀=0, and PDSCH mapping Type B, the starting symbol S is relative to the starting symbol S₀ of the PDCCH monitoring occasion where DCI format 1_2 is detected.
Set [symbol] (R) to the cardinality of R
Set r=0—index of row in set R
if slot n_{U} starts at a same time as or after a slot for an active DL BWP change on serving cell c or an active UL BWP change on the PCell and slot └(n_{U}−K_{1,k})·2^{μ}^{_{DL}}^{-μ}^{_{UL}}┘+n_{D} is before the slot for the active DL BWP change on serving cell c or the active UL BWP change on the PCell

else ⁿ_{D}^{= n}_{D}⁺ ^{1;}
while ^{r <} [symbol] ^{(R)}

Because of the search space configuration by the gNB, the set of monitoring occasions may or may not exist in all the slots, while satisfying the requirement of monitoring all slots with the same (X,Y). One example is illustrated in FIG. 5.

FIG. 5 is a timing diagram illustrating an example of configured monitoring occasions, where each slot has monitoring occasions with the same starting symbols (e.g., symbols 1, 5 and 10) if the monitoring occasions exist in a slot. The monitoring occasions are allowed to be absent in slot. As illustrated, slot (j+1) does not contain any monitoring occasion, and slot (j+2) does not contain a monitoring occasion for starting symbol #5.

For cases with absent monitoring occasions, in some embodiments, the union of starting symbols of monitoring occasions across all slots are used in building set R. This allows a common set of R to be used in constructing Type-1 HARQ-ACK codebook regardless of the slot (or subslot) index for HARQ-ACK transmission, when using relative SLIV. A consequence is, in a given downlink slot, for the absent monitoring occasions, entries are added to set R even if these monitoring occasions do not exist for potential PDCCH which may schedule a PDSCH transmission.

In some embodiments, absent monitoring occasions are skipped when building set R, i.e., absent monitoring occasions do not add any rows to set R. This controls the size of a set R by excluding useless rows. A consequence is the set R may vary from slot to slot.

For time division duplex (TDD) (also known as unpaired spectrum) or half-duplex frequency division duplex (FDD), the UE does not perform monitoring for configured monitoring occasions that overlap symbols designated downlink symbols. Such monitoring occasions can be considered absent monitoring occasions and processed using methods described for absent monitoring occasions.

Other than TDD and half-duplex FDD, other reasons may also cause UE not to monitor some monitoring occasions. For example, pre-configured monitoring occasions that overlap with guard symbols; symbols for monitoring MIB or SIB1, etc. Such monitoring occasions may be considered absent monitoring occasions and processed using methods described for absent monitoring occasions.

Some embodiments include overlapping PDSCH reception candidates in a slot due to multiple values of S₀. When constructing the Type-1 HARQ-ACK codebook, all row indices in the set R (containing all possible PDSCH reception candidates in a slot) are considered and pruned so that only the non-overlapping PDSCH reception candidates contribute to the overall codebook size.

For the new relative SLIV based on starting symbol of PDCCH monitoring occasions, the set R may contain multiple overlapping PDSCH reception candidates due to multiple possible values of S₀. It is possible to avoid this when constructing the set R.

In some embodiments, the set of row indices R is formed in such a way that a new row is added only if it does not result in a PDSCH reception candidate which overlaps with other PDSCH reception candidates due to other possible values of S₀. One example to form the set R by adding new rows according to this method is provided below.

For each row index of the TDRA table for DCI format 1_2 with a starting symbol S, length L, slot offset K₀=0 and PDSCH mapping type B, for each S₀>0 (in an ascending order of the symbol index from a set of all possible starting symbols of PDCCH monitoring occasions in a slot or across slots), if S+S₀+L≤14 for normal cyclic prefix and S+S₀+L≤12 for extended cyclic prefix and S+S₀≥S+S_{0,previous}+L where S_{0,previous} is the previous S₀ which previously results in the new added row, add a new row index to the set R.

There are other cases where PDCCH monitoring occasions are not actually monitored. For a given RRC configuration of CORESET and search space sets, overbooking may occur in a slot, where the UE monitoring limits are exceeded. The UE monitoring limits include blind decoding limits and CCE limits. When configuration causes the UE monitoring limits to be exceeded, the UE starts to drop search space(s) or PDCCH candidates so that the UE does not need to monitor PDCCH candidates beyond its capabilities.

When overbooking causes dropping of a monitoring occasion, and no monitoring occasion exists any more at the otherwise intended starting symbol, in some embodiments, the monitoring occasions for constructing set R is according to RRC configuration of CORESET and search space sets. Overbooking does not affect the construction of set R. An advantage of this method is simplicity in construction of set R, and the same set of R can be built to cover all slots.

In some embodiments, construction of set R considers the starting symbol(s) that no longer have any monitoring occasions that the UE monitors. For example, such starting symbols and associated monitoring occasions are skipped in building set R. An advantage is a finely tuned set R where useless rows are excluded. A consequence is complexity in construction of R, and that the set R likely varies from slot to slot.

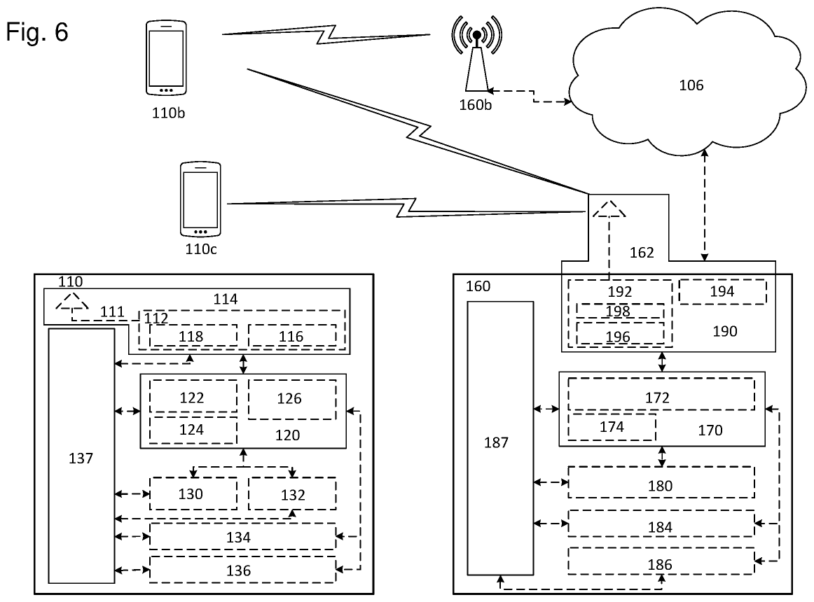

FIG. 6 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 160 includes processing circuitry 170, device readable medium 180, interface 190, auxiliary equipment 184, power source 186, power circuitry 187, and antenna 162. Although network node 160 illustrated in the example wireless network of FIG. 6 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 6 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

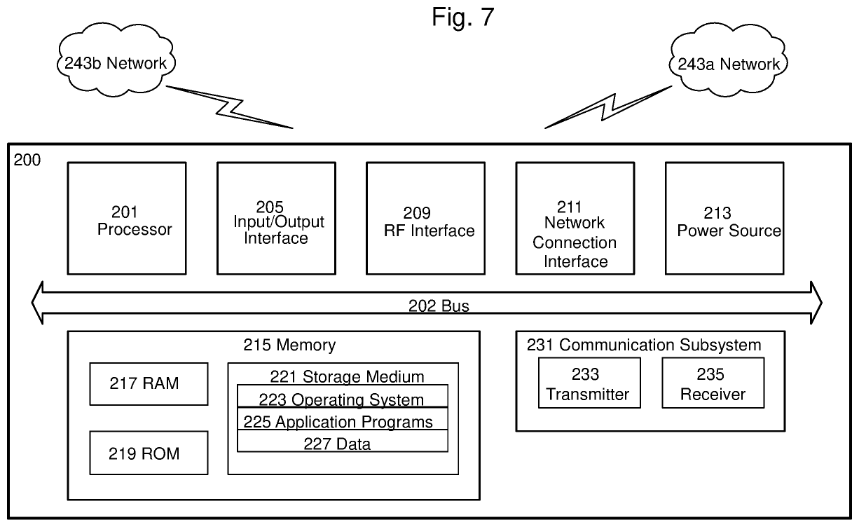

FIG. 7 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may use all the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (MINIM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

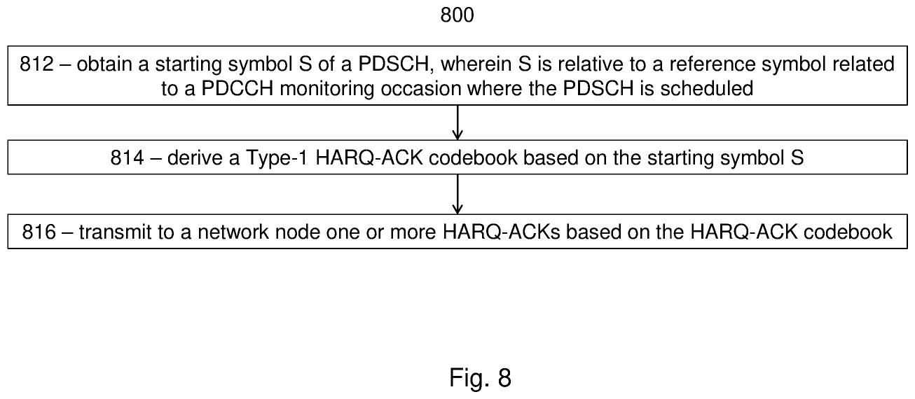

FIG. 8 is a flowchart illustrating an example method in a wireless device, according to certain embodiments. In particular embodiments, one or more steps of FIG. 8 may be performed by wireless device 110 described with respect to FIG. 6. The wireless device is capable of operating in a wireless network where physical PDCCH monitoring occasions vary by slot.

The method begins at step 812, where the wireless device (e.g., wireless device 110) obtains a starting symbol S of a physical downlink shared channel (PDSCH), wherein S is relative to a reference symbol related to a PDCCH monitoring occasion where the PDSCH is scheduled. For example, the wireless device may receive a SLIV value, such as referenceOfSLIVForDCI-Format1-2-r16, from a network node, such as network node 160. The wireless device may obtain S according to any of the embodiments and examples described herein.

At step 814, the wireless device derives a Type-1 HARQ-ACK codebook based on the starting symbol S. There are various options for deriving the HARQ-ACK codebook. The wireless device may derive the HARQ-ACK codebook according to any of the embodiments and examples described herein. Some examples are below.

In particular embodiments, deriving the Type-1 HARQ-ACK codebook comprises deriving a set R containing TDRA entries (e.g., comprising slot offsets K₀, starting symbol relative to slot boundary and length of PDSCH, and PDSCH mapping types) for PDSCH reception with possible starting symbol of PDCCH monitoring occasions.

In particular embodiments, the set R is common for all slots. In some embodiments, all PDCCH monitoring occasion of a span start at the same symbol, a same span pattern repeats in all slots, and starting symbol S is relative to a starting symbol of a monitoring span that contains the PDCCH monitoring occasion where the PDSCH is scheduled. In some embodiments, the Type-1 HARQ-ACK codebook is only derived if starting symbols of PDCCH monitoring occasions are configured the same in all slots. Where PDCCH monitoring occasions are absent in some slots, the Type-1 HARQ-ACK codebook may only be derived if starting symbols of PDCCH monitoring occasions, if not absent, are configured the same in all slots. In some embodiments, the set R includes entries derived from all starting symbols of PDCCH monitoring occasions across all slots.

In particular embodiments, the set R varies across slots.

In particular embodiments, deriving the set R is based on monitoring limits of the wireless device and/or avoiding entries that result in overlapping PDSCH reception candidates.

At step 916, the wireless device transmits to a network node one or more HARQ-ACKs based on the HARQ-ACK codebook.

Modifications, additions, or omissions may be made to method 800 of FIG. 8. Additionally, one or more steps in the method of FIG. 8 may be performed in parallel or in any suitable order.

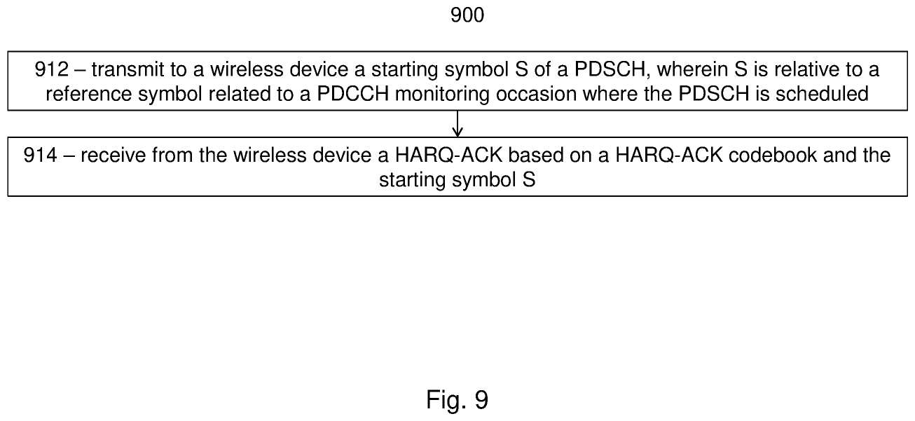

FIG. 9 is a flowchart illustrating an example method in a network node, according to certain embodiments. In particular embodiments, one or more steps of FIG. 9 may be performed by network node 160 described with respect to FIG. 6. The network node is capable of operating in a wireless network where PDCCH monitoring occasions vary by slot.

The method begins at step 912, where the network node (e.g., network node 160) transmits to a wireless device a starting symbol S of a PDSCH. S is relative to a reference symbol related to a PDCCH monitoring occasion where the PDSCH is scheduled. An example of S is described with respect to FIG. 8.

At step 914, the network node receives from the wireless device a HARQ-ACK based on a HARQ-ACK codebook and the starting symbol S. The HARQ-ACK codebook is described with respect to FIG. 8.

Modifications, additions, or omissions may be made to method 900 of FIG. 9. Additionally, one or more steps in the method of FIG. 9 may be performed in parallel or in any suitable order.

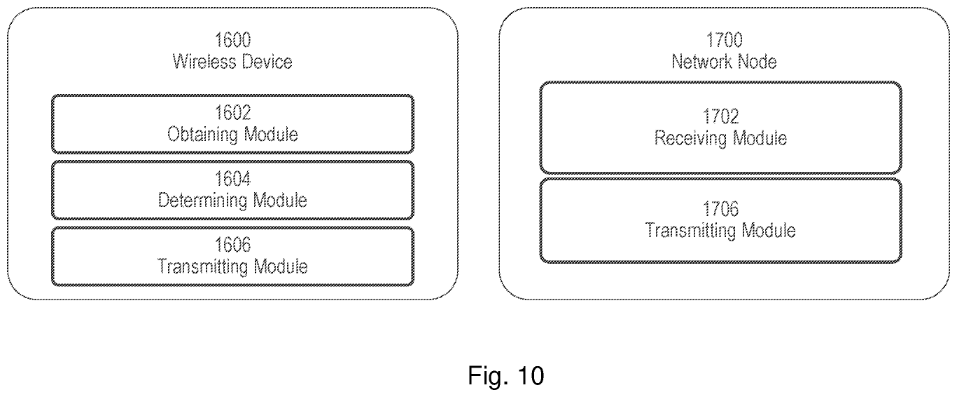

FIG. 10 illustrates a schematic block diagram of two apparatuses in a wireless network (for example, the wireless network illustrated in FIG. 6). The apparatuses include a wireless device and a network node (e.g., wireless device 110 and network node 160 illustrated in FIG. 6). Apparatuses 1600 and 1700 are operable to carry out the example methods described with reference to FIGS. 8 and 9, respectively, and possibly any other processes or methods disclosed herein. It is also to be understood that the methods of FIGS. 8 and 9 are not necessarily carried out solely by apparatus 1600 and/or apparatus 1700. At least some operations of the method can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause obtaining module 1602, determining module 1604, transmitting module 1606, and any other suitable units of apparatus 1600 to perform corresponding functions according one or more embodiments of the present disclosure. Similarly, the processing circuitry described above may be used to cause receiving module 1702, transmitting module 1706, and any other suitable units of apparatus 1700 to perform corresponding functions according one or more embodiments of the present disclosure.

As illustrated in FIG. 10, apparatus 1600 includes obtaining module 1602 configured to obtain a starting symbol S of a PDSCH, wherein S is relative to a reference symbol related to a PDCCH monitoring occasion where the PDSCH is scheduled. Determining module 1604 is configured to determine a HARQ-ACK codebook according to any of the embodiments and examples described herein. Apparatus 1600 also includes transmitting module 1606 configured to transmit a HARQ-ACK to a network node, according to any of the embodiments and examples described herein.

As illustrated in FIG. 10, apparatus 1700 includes receiving module 1702 configured to receive a HARQ-ACK from a wireless device, according to any of the embodiments and examples described herein. Apparatus 1700 also includes transmitting module 1706 configured to transmit a starting symbol S of a PDSCH, wherein S is relative to a reference symbol related to a PDCCH monitoring occasion where the PDSCH is scheduled, to a wireless device according to any of the embodiments and examples described herein.

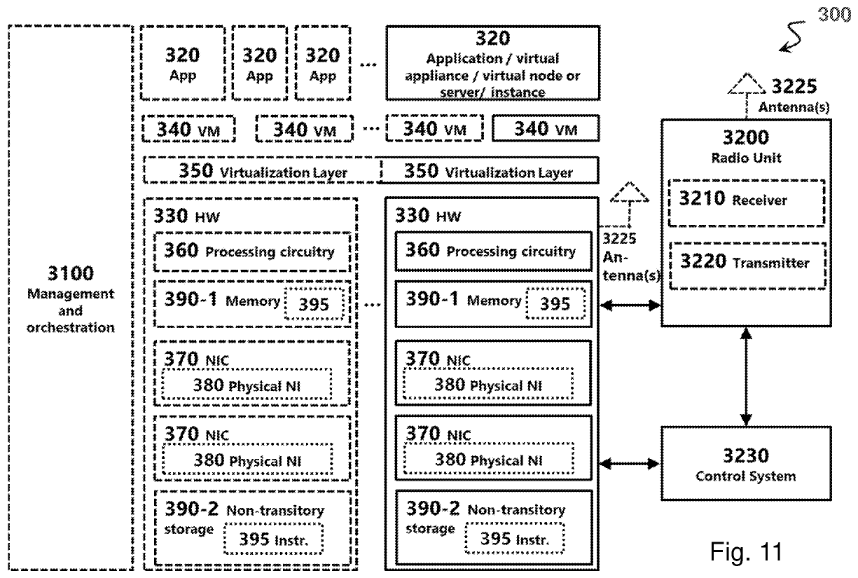

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

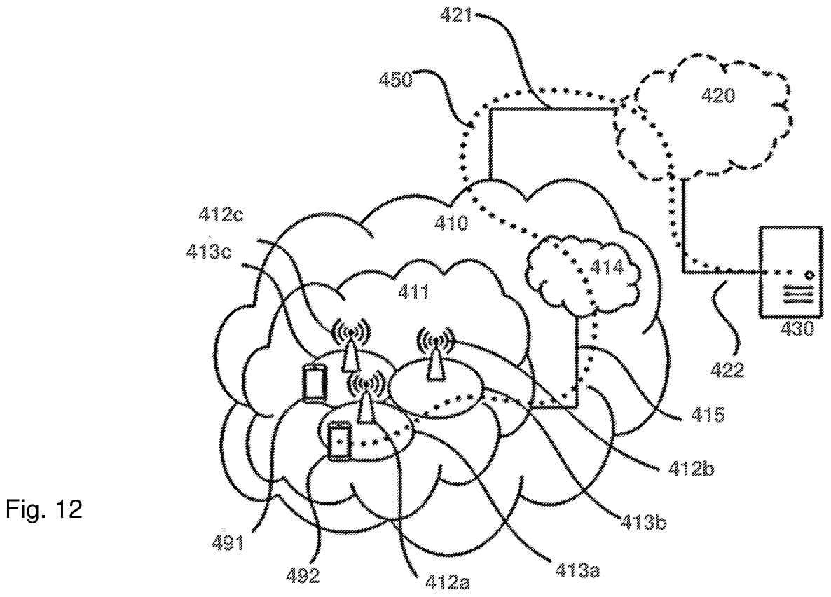

With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

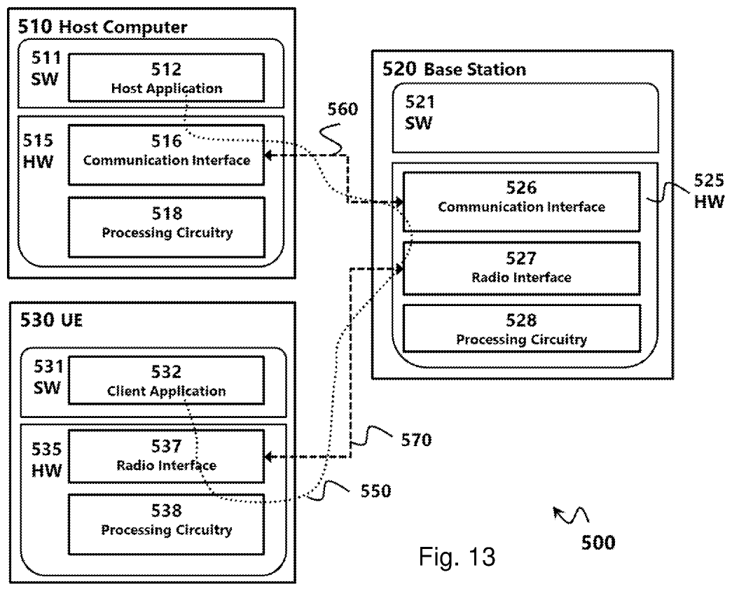

FIG. 13 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct, or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 6, respectively. This is to say, the inner workings of these entities may be as shown in FIG. 13 and independently, the surrounding network topology may be that of FIG. 6.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, and thereby provide benefits such as reduced user waiting time, better responsiveness and extended battery life.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

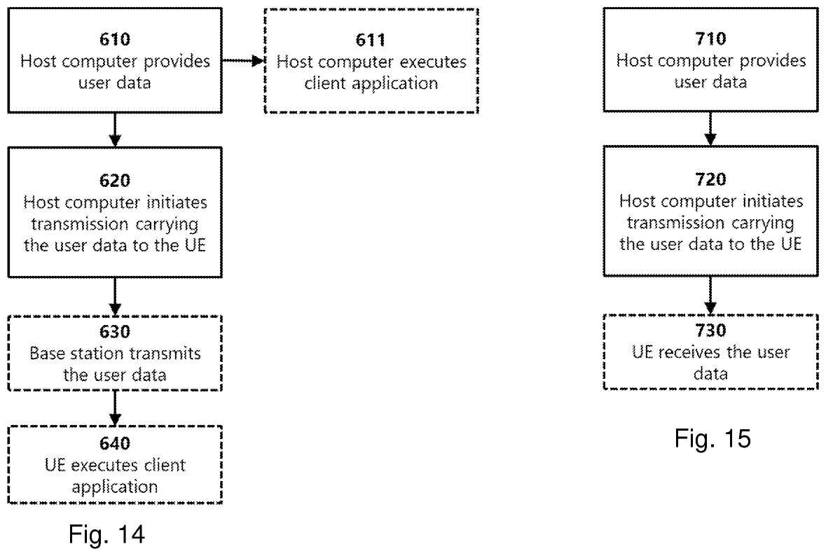

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

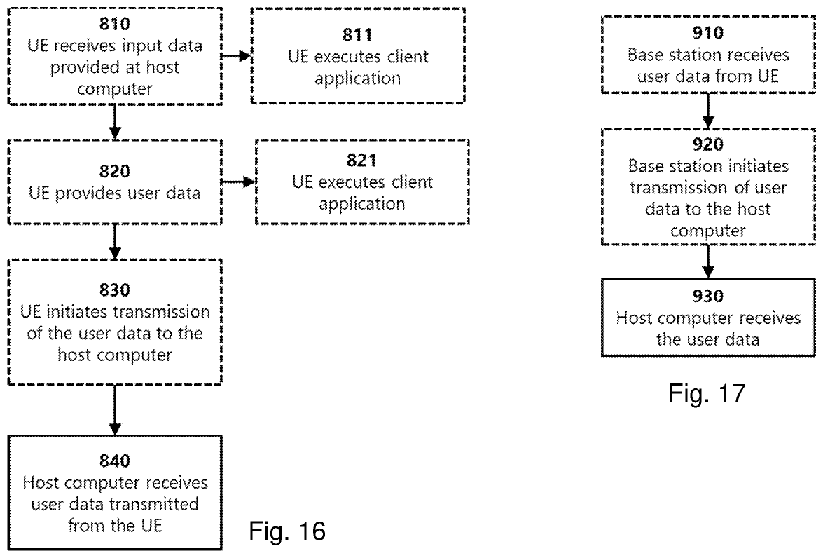

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless device capable of operating in a wireless network where physical downlink control channel (PDCCH) monitoring occasions vary by slot, the method comprising:
obtaining a starting symbol S of a physical downlink shared channel (PDSCH), wherein S is relative to a reference symbol related to a PDCCH monitoring occasion where the PDSCH is scheduled;
deriving a Type-1 hybrid automatic repeat request (HARQ) acknowledgement (ACK) codebook based on the starting symbol S; and
transmitting to a network node one or more HARQ-ACKs based on the HARQ-ACK codebook.

2.-10. (canceled)

11. A wireless device capable of operating in a wireless network where physical downlink control channel (PDCCH) monitoring occasions vary by slot, the wireless device comprising processing circuitry operable to:
obtain a starting symbol S of a physical downlink shared channel (PDSCH), wherein S is relative to a reference symbol related to a PDCCH monitoring occasion where the PDSCH is scheduled;
derive a Type-1 hybrid automatic repeat request (HARQ) acknowledgement (ACK) codebook based on the starting symbol S; and
transmit to a network node one or more HARQ-ACKs based on the HARQ-ACK codebook.

12. The wireless device of claim 11, wherein deriving the Type-1 HARQ-ACK codebook comprises deriving a set R containing time-domain resource allocation (TDRA) entries for PDSCH reception with possible starting symbol of PDCCH monitoring occasions.

13. The wireless device of claim 12, wherein the set R is common for all slots.

14. The wireless device of claim 13, wherein all PDCCH monitoring occasion of a span start at the same symbol, a same span pattern repeats in all slots, and starting symbol S is relative to a starting symbol of a monitoring span that contains the PDCCH monitoring occasion where the PDSCH is scheduled.

15. The wireless device of claim 13, wherein the Type-1 HARQ-ACK codebook is only derived if starting symbols of PDCCH monitoring occasions are configured the same in all slots.

16. The wireless device of claim 13, wherein PDCCH monitoring occasions are absent in some slots and the Type-1 HARQ-ACK codebook is only derived if starting symbols of PDCCH monitoring occasions, if not absent, are configured the same in all slots.

17. The wireless device of claim 13, wherein the set R includes entries derived from all starting symbols of PDCCH monitoring occasions across all slots.

18. The wireless device of claim 12, wherein the set R varies across slots.

19. The wireless device of claim 12, wherein deriving the set R is based on monitoring limits of the wireless device.

20. The wireless device of claim 2, wherein deriving the set R comprises avoiding entries that result in overlapping PDSCH reception candidates.

21. A method performed by a network node capable of operating in a wireless network where physical downlink control channel (PDCCH) monitoring occasions vary by slot, the method comprising:
transmitting to a wireless device a starting symbol S of a physical downlink shared channel (PDSCH), wherein S is relative to a reference symbol related to a PDCCH monitoring occasion where the PDSCH is scheduled; and
receiving from the wireless device a hybrid automatic repeat request (HARQ) acknowledgement (ACK) based on a HARQ-ACK codebook and the starting symbol S.

22.-30. (canceled)

31. A network node capable of operating in a wireless network where physical downlink control channel (PDCCH) monitoring occasions vary by slot, the network node comprising processing circuitry operable to:
transmit to a wireless device a starting symbol S of a physical downlink shared channel (PDSCH), wherein S is relative to a reference symbol related to a PDCCH monitoring occasion where the PDSCH is scheduled; and
receive from the wireless device a hybrid automatic repeat request (HARQ) acknowledgement (ACK) based on a HARQ-ACK codebook and the starting symbol S.

32. The network node of claim 31, wherein the Type-1 HARQ-ACK codebook is derived from a set R containing time-domain resource allocation (TDRA) entries for PDSCH reception with possible starting symbol of PDCCH monitoring occasions.

33. The network node of claim 32, wherein the set R is common for all slots.

34. The network node of claim 33, wherein all PDCCH monitoring occasion of a span start at the same symbol, a same span pattern repeats in all slots, and starting symbol S is relative to a starting symbol of a monitoring span that contains the PDCCH monitoring occasion where the PDSCH is scheduled.

35. The network node of claim 33, wherein the Type-1 HARQ-ACK codebook is only derived if starting symbols of PDCCH monitoring occasions are configured the same in all slots.

36. The network node of claim 33, wherein PDCCH monitoring occasions are absent in some slots and the Type-1 HARQ-ACK codebook is only derived if starting symbols of PDCCH monitoring occasions, if not absent, are configured the same in all slots.

37. The network node of claim 33, wherein the set R includes entries derived from all starting symbols of PDCCH monitoring occasions across all slots.

38. The network node of claim 32, wherein the set R varies across slots.

39. The network node of claim 32, wherein the set R is based on monitoring limits of the wireless device.

40. The network node of claim 32, wherein the set R avoids entries that result in overlapping PDSCH reception candidates.
